(19) United States
(12) Patent Application Publication
(10) Pub. No.: US 2017/0306097 A1
(43) Pub. Date: Oct. 26, 2017

(54) METHOD FOR PRODUCING ORGANOFUNCTIONAL SILICONE RESINS

(71) Applicant: Wacker Chemie AG, Munich (DE)

(72) Inventor: Frank SANDMEYER, Burgkirchen (DE)

(73) Assignee: Wacker Chemie AG, Munich (DE)

(21) Appl. No.: 15/511,451

(22) PCT Filed: Sep. 16, 2015
(86) PCT No.: PCT/EP2015/071242

§ 371 Date: Mar. 15, 2017

(30) Foreign Application Priority Data
Sep. 19, 2014 (DE) 10 2014 218 918.7

(51) Int. Cl. C08G 77/10; C08G 77/08; C08G 77/20; C08G 77/18; C08G 77/00

(52) U.S. Cl. CPC C08G 77/10; C08G 77/20; C08G 77/18; C08G 77/08; C08G 77/70; C08G 77/80

(57) ABSTRACT

Organofunctional organopolysiloxanes resins are prepared by reaction of a reactive silicone resin with a symmetrically substituted disiloxane in the presence of a heterogeneous activated silicate catalyst.

### CROSS REFERENCE TO RELATED APPLICATIONS

This application is the U.S. National Phase of PCT Appln. No. PCT/EP2015/071242 filed Sep. 16, 2015, which claims priority to German Application No. 10 2014 218 918.7 filed Sep. 19, 2014, the disclosures of which are incorporated in their entirety by reference herein.

### BACKGROUND OF THE INVENTION

### 1. Field of the Invention

The invention relates to a method for producing organofunctional silicone resins with low alkoxy-group content and with high tolerance toward a large number of organofunctional groups, especially toward acid-sensitive and base-sensitive organic groups, and also to the organofunctional silicone resins obtainable by this method, and to their use.

### 2. Description of the Related Art

For the production of organofunctional silicone resins there are various methods.

One frequently employed method starts from silicone resins or their constituent silane mixtures and organofunctional silanes, where the silane mixtures and the organofunctional silanes contain hydrolyzable alkoxy groups. For such a procedure it is possible in principle to use any organofunctional alkoxy silanes whose organofunctional groups are tolerant to hydrolytic conditions.

As just one example of this approach, reference may be made to EP0283009, particularly to example a), where a silicone resin which carries amino-functional alkoxy groups is produced.

U.S. Pat. No. 5,280,098 describes the synthesis of epoxy-functional silicone resins using silanes which carry epoxy-functional alkoxy groups, leading to silicone resins which carry epoxy-functional alkoxy groups.

When alkoxy-functional starting products are used, the end products will always be alkoxy-rich. Organofunctional silanes of technical and economic relevance generally carry three alkoxy groups. Given that the reactivity of silane-bonded alkoxy groups falls as the number of silane-bonded alkoxy groups goes down, regular hydrolytic reaction conditions cause, in general, reaction of only one or at most two alkoxy groups, meaning that the total number of alkoxy groups bound on the organofunctional silicone resin after the reaction is at least as high as before, or possibly even higher. In order to cause the remaining alkoxy groups to react, it is necessary for there to be either reaction conditions which lead to the crosslinking of the organofunctional silicone resins to form insoluble products, thus ultimately the conditions which would typically be selected for curing of the materials following application, or else very long reaction times, of the kind, therefore, that apply, for example, during the multiple years of service of the end products.

Also known, as an alternative to this, is the procedure starting from silane mixtures which also include organofunctional silanes, the silanes in each case carrying a sufficient number of hydrolyzable groups, and the oligomeric or polymeric silicone resin structures being produced by hydrolysis and condensation with retention of the organic function. As examples of this, reference may be made to specifications DE10151264A1 and DE10335178 A1, where organic functions in question are amino groups. Here, the hydrolysis and condensation of alkoxy silane mixtures are used to construct alkoxy-rich organofunctional resin structures which are oligomeric—that is, are of low molecular mass. The organic function is retained; the alkoxy groups are partly hydrolyzed, and the resulting silanol groups condense with elimination of water to form silicone resin framework structures. Oligomeric structures of this kind contain a particularly large number of alkoxy groups. In the case of this procedure, moreover, there is a limitation to end products of low molecular mass.

EP1010714 describes the synthesis of silyl hydride-functional silicone resins from alkoxy silicate mixtures and alkoxysilane mixtures with Si—H-functional siloxane components such as tetramethyldisiloxane, for example, under acidic hydrolytic conditions. The siloxane framework is constructed at the same time as the functionalization by hydrolysis and condensation. Sulfonic acids or phosphoronitrile compounds are used as catalysts. Chlorosilanes do not function as raw materials with this method, since the hydrochloric acid formed from chlorosilanes by hydrolysis leads to partial scission of the Si—H bonds. That would make it impossible to control the Si—H content of the resin.

The synthesis presented is limited to siloxanes having silicatic structural elements. On account of the difficult boundary conditions, this procedure is not widely employed. Epoxy groups are incorporated subsequently, by hydrosilylation. Even if no Si—H groups are lost during the hydrolysis, in the case of such reactions, the only polymers available among those which are formed at random are the ones which are accessible sterically, which implies a further uncertainty with this procedure.

EP1398338 teaches the synthesis of vinyl-functional silicone resins having low alkoxy contents, in a multistage synthesis which employs both acidic and basic conditions. The silicone resins are first condensed acidically from alkoxy silanes and functional disiloxanes, and the alkoxy groups that remain in this process are subsequently subjected to basic hydrolysis, thus forming silanol groups. Under these conditions, the silanol groups are not stable, instead condensing with elimination of water and formation of high molecular mass silicone resins. This procedure is tied to functional groups which withstand these reaction conditions intact. The method, for example, is not tolerant toward epoxide groups, carboxyl groups, and amino groups, since such groups would undergo conversions during the method as a result of chemical reactions.

US20030105246A1 discloses, in the examples, methods for producing silicone resins using very strong bases such as, for example, CsOH and KOH as catalysts.

In the present text, substances are characterized by reporting of data obtained by means of instrumental analysis. The measurements involved either are carried out in accordance with publically available standards, or are determined according to specially developed methods. In order to ensure that the teaching given is clear, the methods used are reported here:

### Viscosity:

Unless otherwise reported, the viscosities are determined by rotational-viscosimetric measurement in accordance with DIN EN ISO 3219. Unless otherwise reported, all viscosity reports are valid at 25° C. and atmospheric pressure of 1013 mbar.

### Refractive Index:

The refractive indices are determined in the wavelength range of visible light—unless otherwise reported, at 589 nm at 25° C. under atmospheric pressure of 1013 mbar in accordance with standard DIN 51423.

### Transmission:

The transmission is determined by UV VIS spectroscopy. An example of a suitable instrument is the Jena Specord 200 analytical system.

The measurement parameters used are as follows: range: 190-1100 nm,

Step length: 0.2 nm, integration time: 0.04 s, measurement mode: step operation. First there is a reference measurement (Background). A quartz plate mounted on a sample holder (quartz plate dimensions: H×W approx. 6×7 cm, thickness approx. 2.3 mm) is inserted into the sample beam path and measured against air.

This is followed by the sample measurement. A quartz plate mounted on the sample holder and with sample applied—layer thickness of applied sample approx. 1 mm—is placed into the sample beam path and measured against air. Internal computation relative to background spectrum yields the transmission spectrum of the sample.

### Molecular Compositions:

The molecular compositions are determined by means of nuclear magnetic resonance spectroscopy (regarding the terminology see ASTM E 386: High-resolution nuclear magnetic resonance spectroscopy (NMR): Terms and symbols), with measurement of the ¹H nucleus and of the ²⁹Si nucleus.

### Description of 1H NMR Measurement

### Solvent: CDCl3, 99.8% d

Sample concentration: about 50 mg/l ml CDCl3 in 5 mm NMR vial
Measurement without addition of TMS, spectral referencing of residual CHCl3 in CDCl3 at 7.24 ppm

### Spectrometer: Bruker Avance I 500 or Bruker Avance HD 500

Probe head: 5 mm BBO probe head or SMART probe head (from Bruker)

### Measuring Parameters:

Pulprog=zg30

### TD=64 k

NS=64 or 128 (depending on the sensitivity of the probe head)

### SW=20.6 ppm

### AQ=3.17 s

### D1=5 s

### SFO1=500.13 MHz

### O1=6.175 ppm

### Processing Parameters:

### SI=32 k

### WDW=EM

### LB=0.3 Hz

Depending on the type of spectrometer used, individual adjustments of the measurement parameters may be required.

### Description of 29Si NMR Measurement

Solvent: C6D6 99.8% d/CCl4 1:1 v/v with 1 wt % Cr(acac)₃ as relaxation reagent
Sample concentration: about 2 g/1.5 ml solvent in 10 mm NMR vial
Spectrometer: Bruker Avance 300
Probe head: 10 mm 1H/13C/15N/29Si glass-free QNP probe head (from Bruker)

### Measuring Parameters:

Pulprog=zgig60

### TD=64 k

NS=1024 (depending on the sensitivity of the probe head)

### SW=200 ppm

### AQ=2.75 s

### D1=4 s

### SFO1=300.13 MHz

### O1=−50 ppm

### Processing Parameters:

### SI=64 k

### WDW=EM

### LB=0.3 Hz

Depending on the type of spectrometer used, individual adjustments of the measurement parameters may be required.

### Molecular Weight Distributions:

Molecular weight distributions are determined as weight averages Mw and as number averages Mn, using the method of gel permeation chromatography (GPC or Size Exclusion Chromatography (SEC)) with polystyrene standard and refractive index (RI) detector. Unless otherwise noted, THF is used as mobile phase and DIN 55672-1 applies. The polydispersity is the Mw/Mn quotient.

### Glass Transition Temperatures:

The glass transition temperature is determined according to Differential Scanning Calorimetry (DSC) according to DIN 53765, perforated crucible, heating rate 10 K/min.

### Problem:

The problem addressed was therefore that of providing a method allowing the production of organofunctional silicone resins which have a low alkoxy group content and are tolerant towards as large as possible a number of organofunctional groups, including in particular toward acid-sensitive and base-sensitive organic groups. The problem is solved by the present invention.

### SUMMARY OF THE INVENTION

The invention is directed to solving the problems identified above, by reacting a silicone resin having appropriate organofunctional groups with a symmetrical disiloxane in the presence of a heterogenous activated silicate catalyst.

### DETAILED DESCRIPTION OF THE PREFERRED EMBODIMENTS

The invention is thus directed to a method for producing silicone resins (i) composed of units of the formulae (Ia), (Ib), (Ic) and (Id)

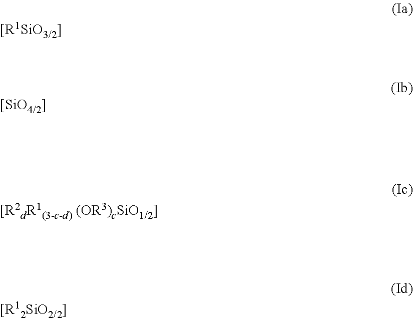

where
   R¹ each is an identical or different monovalent hydrocarbyl radical and
   R² each independently is hydrogen or a monovalent organofunctional hydrocarbyl radical,
   R³ each independently is a monovalent hydrocarbyl radical or a hydrogen radical,
   d is 0 or 1, and
   c is 0 or 1 or 2
with the proviso that,
   at least 20 mol % of (Ia) or (Ib) or combinations thereof,
   at least 3 mol % of (Ic), and
   not more than 60 mol % of (Id)
are included,
and with the proviso that c is always 0 if d is 1,
   by reaction of silicone resins (ii) composed of units of the formulae (Ia), (Ib), (Ie) and (Id)

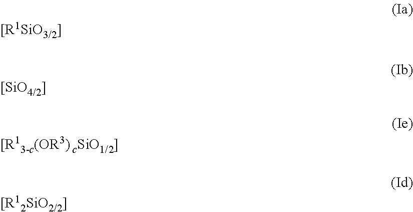

where R¹, R³ and c have the definitions indicated above, the formulae (Ia), (Ib), (Ie) and (Id) are present in the correct ratio to one another in order to obtain the branched silicone resins (i),
   with disiloxane (iii) of the formula (III)

[R¹_{(3-d)}R²_{d}Si]₂O (III),
where R¹ and R² and d have the definitions indicated above, and the disiloxanes (iii) are of symmetrical construction, so that the radicals R¹ and R² on both silicon atoms each have the same definition,
   in the presence of a heterogeneous activated silicate catalyst (iv), in an amount of 0.1 to 10 wt %, based on the total amount of silicone resin (ii) and disiloxane (iii) used
   by
   A) mixing
at least one silicone resin (ii) mixed or dissolved in organic solvent
with at least one disiloxane (iii) and
with at least one heterogeneous activated silicate catalyst (iv),
   B) subsequently heating the mixture, and
   C) purifying the resulting silicone resin (i).

A further subject-matter of the present invention is directed to silicone resins (i) composed of units of the formulae (Ia), (Ib), (Ic) and (Id)

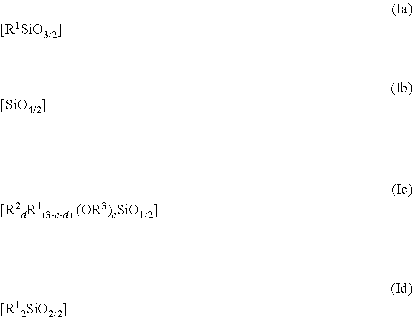

where
   R¹ each independently are monovalent hydrocarbyl radicals and
   R² each independently is hydrogen or a monovalent organofunctional hydrocarbyl radical,
   R³ each independently is a monovalent hydrocarbyl radical or a hydrogen radical,
   d is 0 or 1, and
   c is 0 or 1 or 2
with the proviso that,
   at least 20 mol % of (Ia) or (Ib) or combinations thereof,
   at least 3 mol % of (Ic), and
   not more than 60 mol % of (Id)
are included,
and with the proviso that c is always 0 if d is 1,
   obtainable by
   the reaction of silicone resins (ii) composed of units of the formulae (Ia), (Ib), (Ie) and (Id)

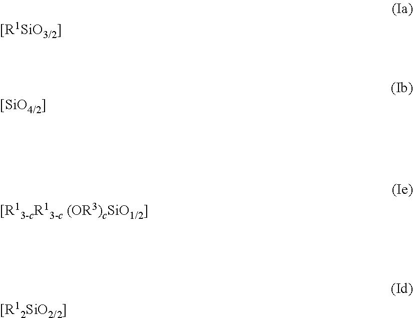

where R¹, R³ and c have the definitions indicated above, the formulae (Ia), (b), (Ie) and (Id) are present in the correct ratio to one another in order to obtain the branched silicone resins (i),
   with disiloxane (iii) of the formula (III)

[R¹_{(3-d)}R²_{d}Si]₂O (III),
where R¹ and R² and d have the definitions indicated above, and the disiloxanes (iii) are of symmetrical construction, so that the radicals R¹ and R² on both silicon atoms each have the same definition,
   in the presence of a heterogeneous activated silicate catalyst (iv), in an amount of 0.1 to 10 wt %, based on the total amount of silicone resin (ii) and disiloxane (iii) used
   by
   A) mixing
at least one silicone resin (ii) mixed or dissolved in organic solvent
with at least one disiloxane (iii) and
with at least one heterogeneous activated silicate catalyst (iv),
   B) subsequently heating the mixture, and
   C) purifying the resulting silicone resin (i).

Through the method of the invention, in the silicone resins (i) of the invention that are produced, at least 20 mol %, preferably at least 25 mol %, more preferably at least 30 mol %, and most preferably at least 35 mol % of units (Ia) or (Ib) or combinations thereof are included. With particular preference there are only units of either the formula (Ia) or (Ib) present, and with particular preference, for certain application profiles, only units of the formula (Ia) are present, since (Ib) units may easily lead to possibly unwanted embrittlement.

The nature and the proportion of the (Ic) and (Id) units serve for adjustment of the mechanical properties and the reactivity, with an increase resulting in an increase in the softness and flexibility of the silicone resin (i).

Through the method of the invention, in the silicone resins (i) of the invention that are produced, at least 3 mol %, preferably at least 5 mol %, more preferably at least 8 mol %, and most preferably at least 10 mol % of the units of the formula (Ic) are included. The remaining units may be those of the formula (Id), in which case the units of formula (Id) account for at most 60 mol %, preferably at most 55 mol %, more preferably at most 50 mol %, and most preferably at most 45 mol % of the total number of units in the silicone resins (i) of the invention.

In the silicone resins (i) produced in accordance with the invention, organofunctional groups R² are included in principle only in the units of the formula (Ic) and, moreover, there is always no more than one functional group R² per unit of the formula (Ic). It is preferred, moreover, for d to be 1 in at least 25%, preferably in at least 30%, more preferably in at least 35%, and most preferably in at least 40% of the units of the formula (Ic).

It is characteristic of the method of the invention that the silicone resins (ii) always have more OR³ groups per molecule than the silicon resins (i), since the method of the invention reduces the number of OR³ groups.

The silicone resins (i) or mixtures thereof that are obtainable by the method of the invention are able to undergo reaction with suitably functionalized reaction partners, which, for example, may themselves be polyorganosiloxanes, organic polymers, functional surfaces of solids, monomers carrying at least two suitable functional groups, to form chemically crosslinked reaction products. In this context, the reaction partners of the silicone resins (i) need not only carry functional groups which are able to react with the organofunctional groups R² of the silicone resins (i), but may instead, additionally, also carry groups with which they are able to undergo further reaction with other reaction partners. One example of this are, for instance, trialkoxy-functional silanes which carry, on the fourth silicon valence, an organofunctional group, as for example an amino group, which is reactive toward R²=epoxy group, for example. With the alkoxy groups, the silane in question is able to react after hydrolysis, by condensation with other silanes of its own kind, to form a silicone resin network. The chemically crosslinked reaction products may be hard, solid products, such as moldings, sheetlike structures, such as coatings, filling compounds for filling cavities or the like, this recitation being only by way of example and being nonlimiting.

The silicone resins (i) produced in accordance with the method of the invention, or the mixture of two or more silicone resins (i), is preferably a preparation made up of not more than three different silicone resins (i), more preferably made up only of the silicone resins (i), more particularly made up of only one silicone resin (i) having, of course, the molecular weight distribution provided for a polymer.

Those of the silicone resins (i) that are produced in accordance with the method of the invention are preferably those having a molecular weight Mw of at least 800, preferably at least 1000, more preferably at least 1200, and most preferably of at least 1400, the polydispersity being at most 20, preferably at most 18, and most preferably at most 15, more particularly at most 10.

In the form of pure substances, the silicone resins (i) produced in accordance with the invention are liquid or viscous to highly viscous or solid substances at 25° C. under atmospheric pressure of 1013 mbar. They possess viscosities of at least 500 mPas, preferably at least 1000 mPas, and more preferably at least 1500 mPas. In a further preferred embodiment, the branched polyorganosiloxanes containing repeating units of the formula (I) are high-viscosity substances having a viscosity of at least 8000 mPas, more preferably at least 10,000 mPas, and most preferably at least 12,000 mPas. In a likewise preferred form, the branched polyorganosiloxanes containing repeating units of the formula (I) are non-sagging compositions which are no longer fluid at room temperature of 25° C. but have a surface which is still tacky, or are tack-free solid bodies having a glass transition temperature of more than 25° C. All reports of viscosity are valid at 25° C. and under atmospheric pressure of 1013 mbar.

The silicone resins (i) produced in accordance with the invention are soluble in suitable organic solvents, the suitable solvent being selected as a function of the particular organic functional group. It is judicious to select solvents which are not reactive toward the organic functional group, with the well-documented chemical reactivities, known from standard works of the chemical literature, being observed here.

Proving most suitable are aromatic solvents, such as toluene, xylene, ethylbenzene or mixtures thereof.

In the silicone resins (i) produced in accordance with the invention, there must always be sufficient organofunctional hydrocarbyl radicals R² present in order to allow reaction with another reaction partner—one carrying functional groups—to form a chemically crosslinked product. Depending on the functional density, slightly crosslinked elastomeric reaction products or else highly crosslinked hard reaction products are possible, both for the silicone resin (i) produced in accordance with the invention, and for the reaction partners, with a loss of the physical solubility in solvents as a result of the chemical crosslinking.

R² denotes a hydridically silicon-bonded hydrogen or organofunctional hydrocarbon radicals, such as, for instance, glycol radicals and functional organic groups from the group of the phosphoric esters, phosphonic esters, epoxide functions, methacrylate functions, carboxyl functions, acrylate functions, amino functions, olefinically or acetylenically unsaturated hydrocarbons.

The organofunctional hydrocarbyl radicals R² may optionally be substituted, meaning that, for example, an amino group may take the form alternatively of a primary amine, a secondary amine or a tertiary amine. It is also possible for two or more nitrogen groups to be present in one relatively long hydrocarbyl radical, such as in the propylaminoethylamine radical (—CH₂)₃NH(CH₂)₂NH₂, for example. Epoxy groups may be incorporated within a hydrocarbon chain, may be incorporated terminally, or may be present in fused form on a cyclic hydrocarbon.

The organofunctional hydrocarbyl radicals R² may optionally be hydroxy-, alkyloxy- or trimethylsilylterminated. In the main chain, nonadjacent carbon atoms may be replaced by oxygen atoms.

The functional groups in the organofunctional hydrocarbyl radicals R² are generally not present directly bonded on the silicon atom. One exception to this is formed by the olefinic or acetylenic groups, which may also be present in directly silicon-bonded form, especially the vinyl group. The remaining functional groups are bonded to the silicon atom via spacer groups, the spacer always being in Si—C-bonded form.

The spacer here is a divalent hydrocarbyl radical which comprises 1 to 30 carbon atoms and in which nonadjacent carbon atoms may be replaced by oxygen atoms, and which may also comprise other heteroatoms or heteroatomic groups, this being not preferred.

The methacrylate group, the acrylate group and the epoxy group as functional groups are present in R² bonded to the silicon atom preferably via a divalent hydrocarbyl radical which preferably comprises 3 to 15 carbon atoms, more preferably 3 to 8 carbon atoms, and most preferably a divalent hydrocarbon radical comprising three carbon atoms and optionally, furthermore, not more than one to 3 oxygen atoms, preferably not more than one oxygen atom; the carboxyl group is preferably bonded via a divalent hydrocarbon radical which preferably comprises 3 to 30 carbon atoms, more preferably 3 to 20 carbon atoms, most preferably a divalent hydrocarbon radical which comprises 3 to 15 carbon atoms and optionally, furthermore, not more than one to 3 oxygen atoms, preferably not more than one oxygen atom, and in particular no oxygen atom.

Organofunctional hydrocarbyl radicals R² which contain heteroatoms are, for example, carboxylic acid radicals of the general formula (IV)

Y¹—COOH (IV),

where Y¹ is preferably a divalent linear or branched hydrocarbon radical having up to 30 carbon atoms, where Y¹ may contain olefinically unsaturated groups or heteroatoms and the atom bonded to the silicon directly by the radical Y¹ is a carbon atom. Heteroatom-containing fragments which may typically be present in the radical Y¹ are —N(R)—C(═O)—, —C—O—C—, —N(R)—, —C(═O)—, —O—C(═O)—, —C—S—C—, —O—C(═O)—O—, —N(R)—C(═O)—N(R)—, where asymmetrical radicals may be incorporated in both possible directions into the radical Y¹, and R is a hydrogen or a linear or branched hydrocarbyl radical.

If the organofunctional hydrocarbon radical R² is produced in accordance with formula (IV), as for example by ring opening and condensation of a maleic anhydride onto a silanol function, it would denote a radical of the form (cis)-C═C—COOH.

Organofunctional hydrocarbyl radicals R² which contain heteroatoms are additionally, for example, carboxylic ester radicals of the general formula (V)

Y¹—C(═O)O—Y² (V),

where Y¹ has the definition indicated above. The radical Y² preferably denotes hydrocarbyl radicals and accordingly, independently of R¹, preferably has the definition of R¹. Y² may also contain further heteroatoms and organic functions, such as double bonds or oxygen atoms, this not being preferred.

The carboxylic ester radical R² may also be present in oppositely bonded form, and thus may be a radical of the form

Y¹—OC(═O)Y².

Examples of carboxylic anhydride radicals R² are those of the general formulae (VI)

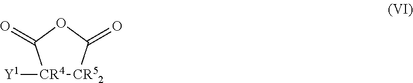

where Y¹ has the definition indicated above and R⁴ and R⁵ independently of one another are each a C1-C8 hydrocarbyl radical or a hydrogen radical, which may optionally contain heteroatoms, this not being preferred.

Examples of phosphonic acid radicals and phosphonic ester radicals R² are those of the general formula (VIII)

Y¹—P(═O)(OR⁶)₂ (VIII),

where Y¹ has the definition indicated above and radicals R⁶ preferably independently of one another denote hydrogen radicals or hydrocarbyl radicals, having up to 18 carbon atoms. Preferred phosphonic acid radicals are those in which R⁶ is hydrogen. Preferred phosphonic ester radicals are those in which R⁶ is methyl or ethyl, this recitation not being intended to be understood in a limiting fashion.

Examples of other organofunctional radicals R² are acryloyloxy and/or methacryloyloxy radicals of the methacrylic esters or acrylic esters such as methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, tert-butyl acrylate, tert-butyl methacrylate, 2-ethylhexyl acrylate, and norbornyl acrylate. Particularly preferred are methyl acrylate, methyl methacrylate, n-butyl acrylate, isobutyl acrylate, tert-butyl acrylate, 2-ethylhexyl acrylate, and norbornyl acrylate.

Examples of preferred radicals R² containing amino groups are the radicals aminoethyl-aminopropyl, aminoethyl-aminoethyl-aminopropyl, N-methylaminopropyl, N-(n-butyl)aminopropyl, N-(n-hexyl)aminopropyl, N-cyclohexylaminopropyl, N-phenylaminopropyl, aminopropyl, N-phenylaminomethyl, N-cyclohexylaminomethyl, N-(n-butyl)aminomethyl, N-(n-hexyl)aminomethyl, N-methylaminomethyl, as examples which should be interpreted illustratively but in no way restrictively.

Examples of preferred olefinically unsaturated hydrocarbyl radicals R² are those of the formula (IX) and (X)

Y¹—CR⁷═CR⁸R⁹ (IX),

Y¹—C≡CR¹⁰ (X),

where Y¹ has the definition indicated above and may additionally denote a chemical bond, this being particularly preferred especially in formula (IX), and the radicals R⁷, R⁸, R⁹, and R¹⁰ are preferably a hydrogen atom or a C1-C8 hydrocarbyl radical which may optionally contain heteroatoms, with the hydrogen atom being the most preferred radical. Particularly preferred radicals (IX) are the vinyl radical, the propenyl radical, and the butenyl radical, particularly the vinyl radical. The radical (IX) may also be a dienyl radical bonded via a spacer, such as the isoprenyl radical or the 1,3-butadienyl radical bonded via a spacer.

Examples of preferred epoxy-functional radicals R² are those of the formulae (XI) and (XII),

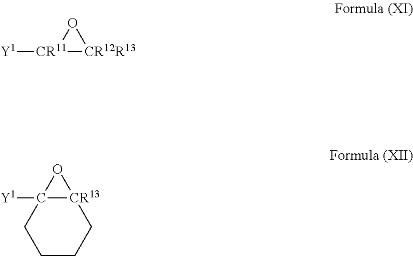

where Y¹ has the definitions indicated above, with Y¹ here not being a chemical bond and it being preferred for Y¹ to be a C3 to C18 hydrocarbyl radical, and the radicals R¹¹, R¹² and R¹³ independently of one another may have the definition of R⁷, with the preferred definition for all radicals R¹¹, R¹², and R¹³ being the hydrogen radical, it being preferred more particularly for all three simultaneously to be a hydrogen radical.

Particularly preferred organofunctional radicals R² are carboxyl-functional, vinyl-functional, and epoxy-functional radicals, and the hydrogen radical.

In principle it is conceivable for the silicone resins (i) to carry different organofunctional groups R². This is only possible, however, if the selected organic groups R² do not react with one another under the conditions of regular storage, i.e., being kept for six months at 25° C., 1013 mbar, in a container with airtight and moisture-tight closure, with one another. Thus, for example, it is not possible to realize epoxy groups and primary amines in the same molecule. In that case, as early as during the attempt to synthesize such a product, there would be a crosslinking reaction to form a possibly insoluble reaction product. Conversely, combinations of vinyl groups and Si—H groups are possible, since their reaction with one another requires significantly different conditions than those of regular storage—a catalyst and elevated temperature, for example. A suitable selection of combinations of functional groups can be derived from the published literature on the chemical reactivity of organofunctional groups.

One particularly preferred combination of different organofunctional groups R² is that composed of hydridic hydrogen and olefinically unsaturated group; in the especially preferred form of this combination, the olefinically unsaturated group is directly silicon-bonded. The most preferred olefinically unsaturated group R² is the vinyl group.

Where there are two or more radicals R¹ or R² in a unit of the silicone resins (i), they may independently of one another be different radicals within the specified group of possible radicals, always subject to the above conditions regarding the organofunctional groups R².

Preferred hydrocarbyl radicals R¹ or R³ are unsubstituted hydrocarbyl radicals having 1 to 16 carbon atoms.

Selected examples of hydrocarbyl radicals as radicals R¹ are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and iso-octyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl, and methylcyclohexyl radicals, alkenyl radicals such as the vinyl radical, aryl radicals such as the phenyl, naphthyl, anthryl, and phenanthryl radical, alkaryl radicals such as tolyl radicals, xylyl radicals, and ethylphenyl radicals, and aralkyl radicals such as the benzyl radical and the β-phenylethyl radical. Particularly preferred radicals R¹ are the methyl, the n-propyl, and the phenyl radical.

Selected examples of radicals R³ are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and iso-octyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl, and methylcyclohexyl radicals, aryl radicals such as the phenyl, naphthyl, anthryl, and phenanthryl radicals, alkaryl radicals such as tolyl radicals, xylyl radicals, and ethylphenyl radicals, and aralkyl radicals such as the benzyl radical and the β-phenylethyl radical and the hydrogen radical, with preference being given to the methyl radical, the ethyl radical, and the hydrogen radical.

### Silicone Resins (ii)

The silicone resins (ii) and/or mixtures thereof composed of two or more silicone resins (ii) preferably comprise a preparation composed of not more than three different silicone resins (ii), more preferably of only two silicone resins (ii), more especially only one such silicone resin (ii), which of course has the molecular weight distribution valid for a polymer.

The silicone resins (ii) are preferably resins having a molecular weight Mw of at least 600, preferably at least 800, more preferably at least 1000, and most preferably of at least 1200, with the polydispersity being not more than 20, preferably not more than 18, more preferably not more than 15, and most preferably not more than 10.

In the form of pure substances, the silicone resins (ii) are liquid or viscous to highly viscous or solid substances at 25° C. and under atmospheric pressure of 1013 mbar. They possess viscosities of at least 400 mPas, preferably at least 900 mPas, more preferably at least 1400 mPas. In a further preferred embodiment, the silicone resins (ii) are substances of high viscosity, having a viscosity of at least 7000 mPas, more preferably at least 9000 mPas, and most preferably at least 11,000 mPas. In a likewise preferred form, the silicone resins (ii) are sag-resistant compositions which are no longer fluid at room temperature at 25° C. and which have a surface which is still tacky, or are tack-free solids having a glass transition temperature of more than 25° C. All of the above data relating to the viscosity are valid at 25° C. and under atmospheric pressure of 1013 mbar.

The silicone resins (ii)) are likewise soluble in the suitable organic solvents used for step A), the selection of the suitable solvent likewise being dependent on the particular organic functional group. It is judicious to select solvents which at the same time are also suitable for the disiloxane (iii). Proving most ideally suited are aromatic solvents, such as toluene, xylene, ethylbenzene or mixtures thereof.

Disiloxanes (iii)

Examples of preferred disiloxanes (iii) are
[(cyclo-H₂C(O)CH)—O—(CH₂)₃—Si(CH₃)₂]₂O=bis(propylglycidyl)-tetramethyldisiloxane
[H₂C═CH—Si(CH₃)₂]₂O
[H—Si(CH₃)₂]₂O
[HOOC—(CH₂)₁₃—Si(CH₃)₂]₂O

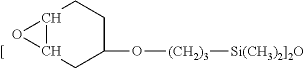

[H₂C═CH—C(═O)—O—(CH₂)₃—Si(CH₃)₂]₂O
[H₂C═C(CH₃)—C(═O)—O—(CH₂)₃—Si(CH₃)₂]₂O
   where this recitation is given by way of example and is therefore not to be taken as imposing any restriction.

### Heterogeneous Activated Silicate Catalyst (iv)

The activated heterogeneous silicate catalysts (iv) are catalysts which as well as SiO_{4/2} comprise further oxidic components, especially those of aluminum, and may also include oxidic constituents of the elements sodium, potassium, iron, and magnesium, in a recitation which is given by way of example and should not be understood as imposing any restriction. The structures in question are preferably tectosilicate or phyllosilicate structures, which may contain water in variable amounts, with typical examples of the silicatic catalysts (iv) being neutral, weakly basic or protonated calcium magnesium aluminum hydrosilicates, comprising, for example, an attapulgite or attapulgus clay or a sepiolite, active bleaching earth and Tonsils, acidically activated hydrosilicates such as, for example, Fuller's earth, colloidal aluminas, such as bentonites or montmorrillonites, and silica gels. The heterogeneously activated silicate catalyst (iv), is used in a amount of 0.1 to 10 wt %, preferably in an amount of 0.3 to 8 wt %, more preferably at 0.5 to 6 wt %, and most preferably of 0.8 to 5 wt %, based on the total amount of silicone resin (ii) and disiloxane (iii) employed.

On account of the specific production method of the invention there are always (Ic) units included. The functional groups R² are therefore always bonded to the (Ic) units. This does not mean, conversely, that every (Ic) unit must carry an organofunctional group R².

It is known that functional groups on M units generally have a greater reactivity than those which are present bonded to D or T units, especially if they are present in directly Si-bonded form.

A particular characteristic of the silicone resins (i), of the invention is that the (Ic) units which carry the organofunctional groups R² do not carry alkoxy groups and do not carry hydroxyl groups. This is a result of the specific production method that is a subject of the present invention, and is deliberately brought about in such a way. This is also the peculiarity of this method relative to the prior art methods, which use alkoxy-functional silanes in order to introduce organofunctional groups, in which case only some of the silane-bonded alkoxy groups present in that case undergo reaction, and in which case there is still a residual quantity of alkoxy groups present after the synthesis. It is this which is avoided specifically by the method of the invention. What is avoided in particular with the method according to the present invention is that the alkoxy groups have to be reduced in a subsequent further reaction step, if desired. Moreover, the use of ready-formed silicone resins (ii) ensures that the organofunctional groups R² applied are preferably in an exposed position in the outer marginal region of the silicone resins (i) of the invention and are therefore readily accessible and available for chemical reactions with a reaction partner having complementary functionalization. This ensures that only a minimum of functional groups R² is needed in order to obtain a cured solid. Since organofunctional groups R² are generally more expensive than standard hydrocarbyl groups without heteroatoms, the synthesis method of the invention is hence highly efficient from an economic standpoint as well.

In accordance with the method of the invention it is possible to produce silicone resins (i) which are virtually free from alkoxy groups. In any case the number of alkoxy groups carried by the silicone resins (i) is lower than the number of alkoxy groups carried by the silicone resins (ii). Alkoxy groups present are, firstly, consumed by the reaction with the siloxane fragments originating from the disiloxanes (iii), with the presence of alkoxy groups not being obligatory for the introduction of the designated siloxane fragments into the silicone resins (ii). Secondly, a certain degree of self-condensation is observed on the part of the silicone resins (ii). The self-condensation can be controlled through the reaction time, the reaction temperature, and the amount of water added. Extending the reaction time generally has the effect of raising the degree of concentration and hence reducing the alkoxy group content. The addition of water and/or increasing the amount of water acts in the same direction. By raising the temperature it is possible to accelerate the progress of the reaction, generally speaking. These adjustment 5 methods act with different effectiveness depending on the starting silicone resin (ii) selected.

The method of the invention encompasses essentially the steps of

A) mixing
at least one silicone resin (ii) which is mixed or dissolved in organic solvent
with at least one disiloxane (iii) and
with at least one heterogeneous activated silicate catalyst (iv),
   B) subsequently heating the mixture, and
   C) purifying the resulting silicone resin (i).

### Method Step A)

Step A) may take place both in the absence and in the presence of water.

In step A), the silicone resins (ii) are dissolved or mixed in an organic solvent. The organic solvents used here are those which dissolve not only the silicone resins (i) but also the silicone resins (ii) and the disiloxanes (iii) at a temperature of 20° C. under atmospheric pressure of 1013 mbar at a concentration of at least 5 wt % in each case, based on the amount of organic solvent used.

These aforementioned individual substeps may be switched as and when required, and the method may be supplemented to include additional operating steps at appropriate points.

A further feature of the method of the invention is that the introduction of the organofunctional group R² on the silicone resin does not require the presence of silicon-bonded alkoxy groups or hydroxyl groups on the silicone resin. While such groups do not cause any disruption, they are unnecessary. If they are present, the number thereof is reduced by the implementation of the method of the invention, since they participate in the reaction, and so the number of silanol groups and of silicon-bonded alkoxy groups comprised in the silicone resins (ii) is always greater than in the silicone resins (i).

### Method Step B)

The heating in method step B) takes place preferably at temperatures which allow operation with the organic solvents under reflux at atmospheric pressure of 1013 mbar. With particular preference these are temperatures of at least 60° C.

### Method Step C)

In method step C), purification is accomplished for example via filtration to remove insoluble constituents and/or distillation to remove the volatile constituents, the order being immaterial.

A feature of the method of the invention is that it is very simple to perform. It encompasses a simple succession of steps which are easy to realize on an industrial scale. It may be operated either batchwise or continuously, in which case the customary equipment can be used, such as column units, leaf (plate) units, agitator units, for instance, which may optionally be interconnected and combined with one another.

The method is robust and tolerant of errors, and is therefore highly unproblematic from standpoints of safety relevance as well. The reactions generally proceed without significant release of energy. No influence of the metering sequence in step A) on the product composition has been found in any case, and consequently the product composition is freely selectable in accordance with the considerations of the optimum operating regime for the plant in question.

The branched silicone resins (i) produced in accordance with the invention can be formulated to compositions by blending them and combining them with suitable liquid or solid components using prior art techniques.

Examples of constituents of such a composition with which the silicone resins (i) produced in accordance with the invention may be blended are fillers, such as reinforcing and nonreinforcing fillers, plasticizers, adhesion promoters, soluble dyes, inorganic and organic pigments, fluorescent dyes, solvents, fungicides, fragrances, dispersing assistants, rheological additives, corrosion inhibitors, oxidation inhibitors, light stabilizers, heat stabilizers, flame retardants, agents for influencing the electrical properties, and agents for improving the thermal conductivity.

The silicone resins (i) produced in accordance with the invention are crosslinked by reaction with suitable functionalized reaction partners; depending on the reactivity of the selected functional groups, it may be necessary to use catalysts, temperature, activating radiation, or other measures as per prior art in order to get the reactions going.

If the silicone resins (i) produced in accordance with the invention possess organofunctional groups that are capable of reaction with one another, they have a capacity for self-crosslinking under appropriate conditions.

Further subject-matters of the invention are shaped articles produced by crosslinking such a composition comprising silicone resins (i) produced in accordance with the invention.

The inventively produced silicone resins (i) are suitable not only for impregnating porous substances, of the kind used, for example, in the electrical insulating material sector (e.g., glass fabric, mica), but also as casting and embedding compounds. Compositions comprising the inventively produced silicone resins (i), in comparison to the known non-organofunctional silicone resins, on account of the generally milder curing conditions, exhibit advantages in particular in processing together with temperature-sensitive components, (e.g., electronic components, casting molds).

Furthermore, the inventively produced silicone resins (i) may also be used for the manipulation of further properties. In preparations comprising i) and also the solid bodies or films produced from them by curing. For example:
Controlling the electrical conductivity and the electrical resistance
Controlling the flow properties of a preparation
Controlling the gloss of a wet or cured film or of an article
Increasing the weathering resistance
Increasing the chemical resistance
Increasing the shade stability
Reducing the propensity to chalking
Reducing or increasing the static and sliding friction on solid bodies or films obtained from preparations comprising a composition preparation of the invention
Stabilizing or destabilizing foam in the preparation comprising inventively produced silicone resins (i)
Improving the adhesion of the preparation comprising an inventively produced silicone resin (i) to substrates or between substrates,
Controlling the filler and pigment wetting and dispersing behavior,
Controlling the rheological properties of the preparation comprising an inventively produced silicone resin (i),
Controlling mechanical properties, such as flexibility, scratch resistance, elasticity, extensibility, bendability, tensile behavior, resilience, hardness, density, tear resistance, compression set, behavior at different temperatures, coefficient of expansion, abrasion resistance, and also further properties such as the thermal conductivity, combustibility, gas permeability, resistance to water vapor, hot air, chemicals, weathering, and radiation, and sterilizability, of solid bodies or films obtainable from preparations comprising an inventively produced silicone resin (i),
Controlling the electrical properties, such as breakdown strength, creep resistance, arc resistance, surface resistance, specific breakdown resistance,
Flexibility, scratch resistance, elasticity, extensibility, bendability, tensile behavior, resilience, hardness, density, tear resistance, compression set, behavior at different temperatures of solid bodies or films obtainable from the preparation comprising the inventively produced silicone resins (i).

Examples of applications in which the inventively produced silicone resins (i) can be used in order to manipulate the properties identified above are the production of shaped parts, coating materials and impregnations, and coverings and coatings obtainable therefrom on substrates, such as metal, glass, wood, mineral substrate, synthetic fibers and natural fibers for producing textiles, carpets, floor coverings, or other products producible from fibers, leather, plastics such as films, moldings. With appropriate selection of the preparation components, the inventively produced silicone resins (i) may be further employed in preparations, as additives for defoaming, promoting flow, hydrophobizing, hydrophilizing, dispersing of filler and pigment, wetting of filler and pigment, substrate wetting, promotion of surface smoothness, reduction of static and sliding friction on the surface of the cured material obtainable from the additized preparation. The composite preparations of the invention can be incorporated in liquid form or in fully cured solid form into elastomer materials. In this context they can be used for reinforcing or for improving other service properties such as the control of transparency, heat resistance, yellowing propensity, and weathering resistance.

### EXAMPLES

Below, examples are given of inventively produced silicone resins (i).

All percentages are based on weight. Unless otherwise indicated, all manipulations are performed at room temperature of approximately 25° C. and under atmospheric pressure (1.013 bar). The equipment involved comprises commercial laboratory apparatus of the kind available commercially from numerous apparatus manufacturers.

Ph denotes a phenyl radical=C₆H₅—
Me denotes a methyl radical=CH₃—.
Me₂ accordingly denotes two methyl radicals.

Because the silanol content could not be determined by ¹H NMR, the BSA method below is used for determining the hydroxyl group content:

The test is based on the reaction of bistrimethylsilylacetamide (=silane BSA) with proton-active substances such as water, alcohols, amines, and silanols. The heat of reaction is determined with a suitably sized commercial calorimeter. The system is calibrated with a 2% strength solution of ethanol in toluene.

The measurement uncertainty for the OH assay with BSA is 0.06%.

### Example 1: H80 with HM2 Groups by Tonsil Equilibration=>SY 430 Method with High Si—H Content (=>JB 88)

A 4 l 4-neck round-bottom glass flask with drain is charged with 500 g of a phenyl silicone resin which is solid at 25° C. under atmospheric pressure of 1013 mbar, which has a molecular weight average Mw of 2900 g/mol (number average Mn=1500) and a glass transition temperature of Tg=52° C., which contains 5.5 wt % of silanol groups and 3.3 wt % of ethoxysilyl groups, and which consists of 100 mol % of PhSiO_{3/2} units, the methoxy groups and the hydroxyl groups being distributed across the stated structural units, and this initial charge is stirred at 60° C. until the phenyl silicone resin has dissolved in 500 g of toluene.

Added to this solution are 149 g of 1,3-divinyl-1,1,3,3-tetramethyldisiloxane [(CH₂═CH)Me₂Si]₂O (186 g/mol=>initial mass 0.80 mol) and 107 g of 1,1,3,3-tetramethyldisiloxane [(H)Me₂Si]₂O (136 g/mol=>initial mass 0.79 mol) and 37.68 g of Tonsil Supreme 114 FF (manufacturer: Clariant). The mixture is boiled under reflux for nine hours, and cooled to below 60° C., and admixed then with 33 g of Seitz EF filter aid, stirred for 15 minutes and filtered over a Seitz K 100 filter plate with a pressure filter.

This gives a clear, colorless solution, which is concentrated by distillation to a liquid-phase temperature of 128° C. This gives 584 g of an 85 wt % strength toluenic solution. The resin contained possesses a molecular weight by SEC (mobile phase THF) of Mw=5400 g/mol and Mn=2700 g/mol.

The silanol content cannot be determined by ¹H NMR because of superimposition of signals.

The vinyl content is 1.32 mmol/g, and the silicon-bonded hydrogen content is 1.56 mmol/g.

The molar composition by ²⁹Si NMR is as follows:
(CH₂═CH)Me₂SiO_{1/2}: 14.1%
Me₂(H)SiO_{1/2}: 19.3%
Ph(OR)₂SiO_{2/2}: 0.0%
Ph(OR)SiO_{2/2}: 11.1%
PhSiO_{3/2}: 55.5%
   where R here is primarily ethyl, and otherwise also hydrogen.

The amount of silanol groups (in the form of hydroxyl groups) in the end product is 0.38 wt %, determined by the BSA method, and the amount of ethoxysilyl groups (in the form of ethoxy content) is 0.12 wt %, with both values therefore having been reduced by a factor of more than 10 relative to the initial resin.

### Sample Preparation:

2 ml of perchloric acid are mixed into 1 l of toluene, stirred for an hour, and filtered through a fluted filter. The filtered solution is stirred further before being used.

The test substance is adjusted to 25° C.

### Procedure:

20 ml of the perchloric acid solution in toluene, and also 2 ml of bistrimethylsilylacetamide (=BSA), are metered into the reaction vessel. This solution is introduced into the calorimeter, and static conditions are awaited. When fluctuation-free temperature constancy has been attained, 5 ml of test substance are metered into the reaction vessel, which is sealed. During the determination of exothermy, the system is stirred. Exothermy is recorded as deflection of an attached plotter.

### Example 2: H80 with HM2 Groups by Tonsil Equilibration=>SY 430 Method with Low Si—H Content (=>AH 506)

A 4 l 4-neck round-bottom glass flask with drain is charged with 500 g of a phenyl silicone resin which is solid at 25° C. under atmospheric pressure of 1013 mbar, which has a molecular weight average Mw of 2900 g/mol (number average Mn=1500) and a glass transition temperature of Tg=52° C., which contains 5.5 wt % of silanol groups and 3.3 wt % of ethoxysilyl groups, and which consists of 100 mol % of PhSiO_{3/2} units, the methoxy groups and the hydroxyl groups being distributed across the stated structural units, and this initial charge is stirred at 60° C. until the phenyl silicone resin has dissolved in 500 g of toluene.

Added to this solution are 133 g of 1,3-divinyl-1,1,3,3-tetramethyldisiloxane [(CH₂═CH)Me₂Si]₂O (186 g/mol=>initial mass 0.71 mol) and 25 g of 1,1,3,3-tetramethyldisiloxane [(H)Me₂Si]₂O (136 g/mol=>initial mass 0.19 mol) and 34.74 g of Tonsil Supreme 114 FF (manufacturer: Clariant). The further procedure is the same as described in example 1.

This gives 581 g of an 83.4 wt % strength toluenic solution.

The resin contained possesses a molecular weight by SEC (mobile phase THF) of Mw=9400 g/mol and Mn=3300 g/mol.

The silanol content cannot be determined by 1H NMR because of superimposition of signals.

The vinyl content is 2.08 mmol/g, and the silicon-bonded hydrogen content is 0.54 mmol/g.

The molar composition by ²⁹Si NMR is as follows:
(CH₂═CH)Me₂SiO_{1/2}: 21.5%
Me₂(H)SiO_{1/2}: 6.0%
Ph(OR)₂SiO_{1/2}: 0.0%
Ph(OR)SiO_{2/2}: 20.7%
PhSiO_{3/2}: 51.8%
   where R here is primarily ethyl, and otherwise also hydrogen.

The amount of silanol groups (in the form of hydroxyl groups) in the end product is 0.44 wt %, and the amount of ethoxysilyl groups (in the form of ethoxy groups) is 0.35 wt %, with both values therefore having been reduced by a factor of approximately 10 relative to the initial resin.

### Example 3: AH 507 SY 430+VSi2

The procedure corresponds to that of example 2, with the difference that in this example 70.93 g of 1,3-divinyl-1,1,3,3-tetramethyldisiloxane [(CH₂═CH)Me₂Si]₂O (186 g/mol=>initial mass 0.38 mol) are used, and no 1,1,3,3-tetramethyldisiloxane [(H)Me₂Si]₂O, meaning that here there are only vinyl functions present. Furthermore, 32 g of Tonsil Supreme 114 FF (manufacturer: Clariant) are used.

This gives 449 g of 81.72 wt % strength toluenic solution. The resin contained possesses by SEC (mobile phase THF) a molecular weight of Mw=4600 g/mol and Mn=2100 g/mol. The silanol content cannot be determined by ¹H NMR owing to superimposition of signals.

The vinyl content is 0.84 mmol/g.

The molar composition by ²⁹Si NMR is as follows:
(CH₂═CH)Me₂SiO_{1/2}: 13.6%
Ph (OR)₂SiO_{1/2}: 1.09%
Ph(OR)SiO_{2/2}: 35.2%
PhSiO_{3/2}: 50.1%
   where R here is primarily ethyl, and otherwise also hydrogen.

The amount of silanol groups (in the form of hydroxyl groups) in the end product is 0.38 wt %, the amount of ethoxysilyl groups (in the form of ethoxy groups) is 0.85 wt %, with both values therefore being reduced significantly relative to the initial resin.

### Example 4: SB 52: SY 430+USi2=Bis (trimethylsilyl undecanoate)-tetramethyldisiloxane

The procedure corresponds to that of example 2, with the difference that in this example 200 g of the phenylsilicone resin are introduced in solution in 200 g of toluene and only one disiloxane is used, which in this case is 1,3-bis(trimethylsilyl undecanoate)-1,1,3,3-tetramethyldisiloxane [((CH₃)₃SiO)C(═O)(CH₂)₁₀)Me₂Si]₂O, of which 124.4 g are used (646 g/mol=>initial mass 0.20 mol), meaning that here there is only one protected carboxylic acid function. Furthermore, 7 g of Tonsil Supreme 114 FF (manufacturer: Clariant) are used. This gives 251 g of 83.5 wt % strength toluenic solution. The resin contained possesses by SEC (mobile phase THF) a molecular weight of Mw=5800 g/mol and Mn=2400 g/mol. The silanol content cannot be determined by 1H NMR owing to superimposition of signals.

After the reaction, the organic radical is present in the form of undecenoic acid; in other words, the protecting group is eliminated.

The molar composition by ²⁹Si NMR is as follows:
((HOOC)(CH₂)₁₀))Me₂SiO_{1/2}: 17.5%
Ph(OR)SiO_{2/2}: 28.9%
PhSiO_{3/2}: 53.6%
   where R here is primarily ethyl, and otherwise also hydrogen.

The amount of silanol groups (in the form of hydroxyl groups) in the end product is 0.08 wt %, the amount of ethoxysilyl groups (in the form of ethoxy groups) is 0.04 wt %, with both values therefore being reduced significantly relative to the initial resin.

### Example 5: SB 74: SY 430+ASi2=Bis (succinic anhydride-allyl)-tetramethyldisiloxane

The procedure corresponds to that of example 2, with the difference that in this example 200 g of the phenylsilicone resin are introduced in solution in 200 g of toluene and only one disiloxane is used, which in this case is 1,3-bis(allyl succinic anhydride)-1,1,3,3-tetramethyldisiloxane [((O═)CO(═O)CCH₂CH—CH₂CH₂CH₂)Me₂Si]₂O, of which 83.2 g are used (414 g/mol=>initial mass 0.20 mol), meaning that here there is only this anhydride function. Furthermore, 8.5 g of Tonsil Supreme 114 FF (manufacturer: Clariant) are used.

This gives 266 g of 67.5 wt % strength toluenic solution.

The resin contained possesses by SEC (mobile phase THF) a molecular weight of Mw=3100 g/mol and Mn=1800 g/mol. The silanol content cannot be determined by 1H NMR owing to superimposition of signals.

The molar composition by ²⁹Si NMR is as follows:
((O═)COC(═O)CH₂CH—CH₂CH₂CH₂)Me₂SiO_{1/2}: 18.1%
Ph(OR)₂SiO_{1/2}: 0.1%
Ph(OR)SiO_{2/2}: 31.6%
PhSiO_{3/2}: 50.2%
   where R here is primarily ethyl, and otherwise also hydrogen.

The amount of silanol groups (in the form of hydroxyl groups) in the end product is 0.12 wt %, the amount of ethoxysilyl groups (in the form of ethoxy groups) is 0.17 wt %, with both values therefore being reduced significantly relative to the initial resin.

### Example 6: Counter Example (not Inventive): SY 430+GF 20

A 2 l 4-neck round-bottomed glass flask with drain is charged with 200 g of a phenyl silicone resin which is solid at 25° C. under atmospheric pressure of 1013 mbar, which has a molecular weight average Mw of 2900 g/mol (number average Mn=1500) and a glass transition temperature of Tg=52° C., which contains 5.5 wt % of silanol groups (in the form of hydroxyl groups) and 3.3 wt % of ethoxysilyl groups (in the form of ethoxy groups) and which consists of 100 mol % of PhSiO_{3/2} units, the methoxy groups and the hydroxyl groups being distributed across the stated structural units, and this initial charge is stirred at 60° C. until the phenyl silicone resin has dissolved in 200 g of toluene.

This solution is admixed first with 1.1 g of fully demineralized water and with 0.48 g of 20% strength aqueous hydrochloric acid, and subsequently with 81.4 g of allylsuccinic acid-triethoxy silane ((O═)CO(═O)CCH₂CH—CH₂CH₂CH₂)Si(OCH₂CH₃)₃.

The mixture is heated to 80° C. and stirred at this temperature for 90 minutes. It is neutralized by addition of 0.42 g of 25% strength aqueous sodium hydroxide. Then 25 g of Seitz EF filter aid are added and, after stirring for 15 minutes, the mixture is filtered over a Seitz K 100 filter plate with a pressure filter. This gives a clear, pale yellowish solution which is concentrated by distillation to a liquid-phase temperature of 128° C. This gives 350 g of a 75 wt % strength toluenic solution.

The resin contained possesses a molecular weight by SEC (mobile phase THF) of Mw=3400 g/mol and Mn=1900 g/mol.

The molar composition by ²⁹Si NMR is as follows:
((O═)COC(═O)CH₂CH—CH₂CH₂CH₂)(OR)_{q}SiO_{3-q/2}: 21.2% (q=0, 1, 2)
Ph(OR) SiO_{2/2}: 38.1%
PhSiO_{3/2}: 39.7%
   where R here is primarily ethyl, and otherwise also hydrogen.

The amount of silanol groups (in the form of hydroxyl groups) in the end product is 6.44 wt %, and the amount of ethoxysilyl groups (in the form of ethoxy groups) is 8.01 wt %, meaning that after the reaction there are more hydroxyl and alkoxy groups present in a form bonded on the resin than before the reaction.

1.-3. (canceled)

4. A method for producing silicone resins (i) comprising units of the formulae (Ia), (Ib), (Ic) and (Id) 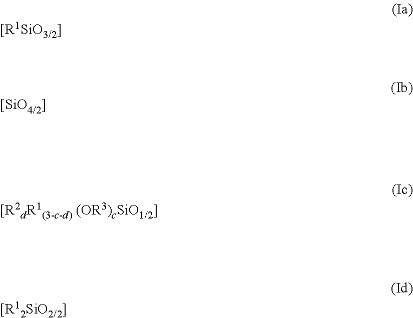
where
R¹ each independently is a monovalent hydrocarbyl radical,
R² each independently is hydrogen or a monovalent organofunctional hydrocarbyl radical,
R³ each independently is a monovalent hydrocarbyl radical or hydrogen,
d is 0 or 1, and
c is 0, 1, or 2
with the proviso that,
at least 20 mol % of (Ia) or (Ib) or combinations thereof are included,
at least 3 mol % of (Ic) are included, and
not more than 60 mol % of (Id)
are included,
and with the proviso that c is always 0 if d is 1,
comprising reacting at least one silicone resin (ii) comprising units of the formulae (Ia), (Ib), (Ie) and (Id) 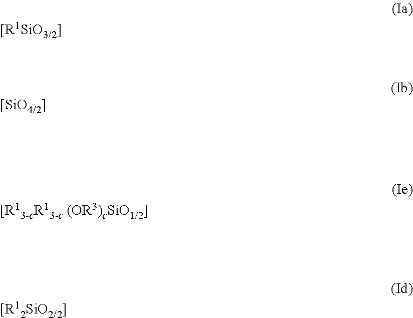
where R¹, R³ and c are as defined above, and
groups of the formulae (Ia), (Ib), (Ie) and (Id) are present in a ratio to one another such as to result in the branched silicone resins (i),
with one or more disiloxanes (iii) of the formula (III)
[R_{(3-d)}R²_{d}Si]₂O (III),
where R¹ and R² and d are as defined above,
and the disiloxanes (iii) are of symmetrical construction, so that the radicals R¹ and R² on both silicon atoms each have the same definition,
in the presence of a heterogeneous activated silicate catalyst (iv), in an amount of 0.1 to 10 wt %, based on the total amount of silicone resin (ii) and disiloxane (iii),
by
A) mixing in any order,
at least one silicone resin (ii) mixed or dissolved in organic solvent,
at least one disiloxane (iii), and
at least one heterogeneous activated silicate catalyst (iv),
B) subsequently heating the mixture obtained from step A), and
C) purifying a resulting silicone resin (i) obtained in step B)
where the heterogeneously activated silicate catalyst (iv) comprises neutral, weakly basic or protonated calcined magnesium aluminum hydrosilicates having tecto- or phyllosilicate structures.

5. A silicone resin (i) comprising units of the formulae (Ia), (Ib), (Ic) and (Id) 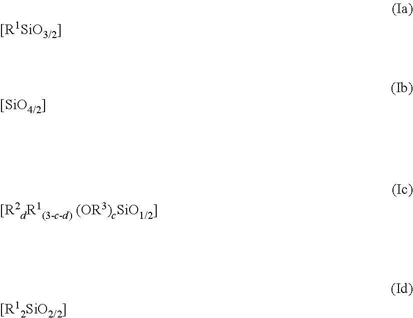
where
R¹ each independently is a monovalent hydrocarbyl radical,
R² each independently is a hydrogen or a monovalent organofunctional hydrocarbyl radical,
R³ each independently is a monovalent hydrocarbyl radical or hydrogen,
d is 0 or 1, and
c is 0 or 1 or 2
with the proviso that,
at least 20 mol % of (Ia) or (Ib) or combinations thereof are included,
at least 3 mol % of (Ic) are included, and
not more than 60 mol % of (Id)
are included,
and with the proviso that c is always 0 if d is 1,
obtained by the process of claim 4.

6. A shaped part, coating material, or impregnation material, comprising a silicone resin (i) of claim 5.
